(19) United States
(12) Patent Application Publication
(10) Pub. No.: US 2013/0139075 A1
(43) Pub. Date: May 30, 2013

(54) IMAGE FORMING DEVICE HAVING A PLURALITY OF PLATFORMS AND METHOD FOR PERFORMING APPLICATION THEREOF

(71) Applicant: Samsung Electronics Co., Ltd., Suwon-si (KR)

(72) Inventor: Hyun-cheol PARK, Hwaseong-si (KR)

(73) Assignee: Samsung Electronics Co., Ltd., Suwon-si (KR)

(21) Appl. No.: 13/687,664

(22) Filed: Nov. 28, 2012

(30) Foreign Application Priority Data
Nov. 30, 2011 (KR) 10-2011-0127365

(51) Int. Cl. G06F 3/048

(52) U.S. Cl. CPC G06F 3/048
USPC 715/762

(57) ABSTRACT

An image forming device includes a storage unit having a plurality of platforms, a UI processing unit configuring an integrated UI which displays applications executable in each platform, a display unit displaying the integrated UI and if an application is selected from the integrated UI, a control unit executing the selected application using a platform corresponding to the selected application. Therefore, a user may execute an application conveniently.

### CROSS-REFERENCE TO RELATED APPLICATIONS

This application claims the priority benefit of Korean Patent Application No. 10-2011-0127365 under 35 U.S.C. §119(a), which was filed on Nov. 30, 2011, in the Korean Intellectual Property Office, the entire disclosure of which is incorporated herein by reference.

### BACKGROUND

1. Field

The following description relates to an image forming device having a plurality of platforms installed therein and an application execution method thereof and, more particularly, to an image forming device providing an integrated user interface (UI) for applications executable in each platform and an application execution method using the image forming device.

2. Description of the Related Art

Due to the development of electronic technologies, various kinds of electronic devices have been developed and provided. In particular, as computerization has been introduced to work places, a variety of computer peripherals are used at work.

A case in point is an image forming device. An image forming device refers to a device which forms an image on paper or other various recording media, For instance, the image forming device is realized as one of a printer, scanner, copy machine, or MFP (Multi Function Peripheral), for example.

Recently, a demand for a user-customized environment has increased in an image forming device. Accordingly, there is provided an environment where a user directly creates an application which can be employed in an image forming device and distributes it by open platforms. Therefore, an additional application may be developed to meet users' needs, separately from applications installed in a basic package at the time of purchasing products. Such applications may be supported by an additional platform, and accordingly a hybrid system having an additional platform installed therein in addition to a basic platform is being developed.

In the case of the hybrid system, there exists a plurality of platforms in one system. The platforms share various system resources, including hardware. Specifically, they can share an LCD, button, CPU, or LED, for example. Each platform provides its own UI.

Under the hybrid system, a user has to find a platform supporting an application that the user wants and select the application through a UI provided by the platform. Therefore, the user must be aware in which platform the application that the user wants is executed.

In addition, a UI provided in each platform must prepare a menu to convert the UI into a different UI.

Accordingly, usability is significantly decreased when the user employs a device.

### SUMMARY

Additional aspects and/or advantages will be set forth in part in the description which follows and, in part, will be apparent from the description, or may be learned by practice of the invention.

Accordingly, the following description addresses above-mentioned disadvantages occurring in the prior art and other related disadvantages not described above. The following description relates to an image forming device which provides an integrated UI displaying applications of each platform and an application execution method thereof.

According to an exemplary embodiment, an image forming device includes a storage unit installing a plurality of platforms therein, a UI processing unit configuring an integrated UI which displays applications executable in each platform, a display unit displaying the integrated UI and a control unit, and if an application is selected from the integrated UI, executing the selected application using a platform corresponding to the selected application.

Herein, the UI processing unit may configure the integrated UI using a main platform among the plurality of platforms and provide the integrated UI with icons for applications executable in each platform according to application information of a sub-platform among the plurality of platforms.

In addition, forms of the icons may be configured individually according to application information of each of the plurality of platforms.

If application information provided by the sub-platform among the plurality of platforms is an image format that can be supported by the main platform, the UI processing unit may configure icons of applications of the sub-platform according to the application information, and if the application information is an image format that cannot be supported by the main platform, it may configure icons of applications of the sub-platform by converting application information into an image format of the main platform and, if it is not possible to convert to the image format, it may configure application icons of the sub-platform in a form of default icons.

If a platform stored in the storage unit changes, the control unit may control the UI processing unit to update the integrated UI according to a state of the changed platform.

The storage unit may include a plurality of platform areas assigned for each of the plurality of platforms and a shared storage area storing data shared in the plurality of platforms.

The integrated UI may include a tab area displayed corresponding to the plurality of platforms and an icon display area, and the icon display area may be displayed in connection with selecting the tab area and displays icons of applications executable in a corresponding platform.

According to an exemplary embodiment, a method for executing an application includes configuring an integrated UI displaying applications executable in a plurality of pre-installed platforms, displaying the integrated UI and, if an application is selected from the integrated UI, executing the selected application using a platform corresponding to the selected application.

The integrated UI may be configured by a main platform among the plurality of platforms and include icons of applications executable in a sub-platform among the plurality of platforms.

Forms of the icons may be configured individually according to application information of each of the plurality of platforms.

The configuring the integrated UI may include forming a layout of an integrated UI using the main platform among the plurality of platforms, determining whether application information provided by the sub-platform among the plurality of platforms is an image format supportable in the main platform, and in the case of a supportable image format, configuring application icons of the sub-platform according to the application information and, in the case of an image format which is not supportable in the main platform, determining whether the application information can be converted into an image format of the main platform, and if the application information can be converted into an image format of the main platform, configuring application icons of the sub-platform as the image format of the main platform and, if the application information cannot be converted into an image format of the main platform, configuring application icons of the sub-platforms in a form of default icons.

If a pre-stored platform changes, the method for executing an application may further include updating the integrated UI according to a state of the changed platform.

The integrated UI may include a tab area corresponding to the plurality of platforms and an icon display area, and the icon display area may be displayed in connection with selecting the tab area and display icons of applications executable in a corresponding platform.

According to an exemplary embodiment, a method for providing an integrated UI of the image forming device includes detecting application information of another platform by a main platform among a plurality of platforms installed in the device, configuring an integrated UI displaying applications executable in the plurality of platforms according to a UI format supported in the main platform and displaying the integrated UI.

In accordance with the exemplary embodiments as described above, a user can easily select a desired application using an integrated UI, resulting in an immediate conversion of platforms and an increase in convenience.

### BRIEF DESCRIPTION OF THE DRAWINGS

The above and other features, aspects and advantages of the present invention will be more apparent from the following detailed description taken in conjunction with the accompanying drawings, in which:

FIG. 1 is a block diagram illustrating an image forming device according to an exemplary embodiment;

FIG. 2 is a view illustrating an example of the configuration of an integrated UI;

FIG. 3 is a view illustrating an example of a configuration of platform according to an exemplary embodiment;

FIG. 4 is a view illustrating another example of the configuration of an integrated UI;

FIG. 5 is a flowchart illustrating an application execution method according to an exemplary embodiment; and

FIG. 6 is a flowchart illustrating a method of providing an integrated UI, according to an exemplary embodiment.

### DETAILED DESCRIPTION

Hereinafter, exemplary embodiments will be described in greater detail with reference to the accompanying drawings.

In the following description, the same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail because they would obscure the exemplary embodiments with unnecessary detail.

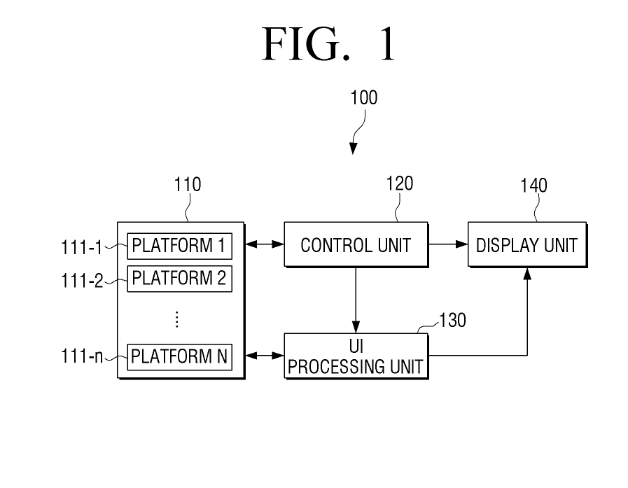

FIG. 1 is a block diagram to explain a configuration of an image forming device according to an exemplary embodiment. Referring to FIG. 1, an image forming device 100 comprises a storage unit 110, a control unit 120, a user interface (UI) processing unit 130, and a display unit 140.

In the storage unit 110, a plurality of platforms 111-1, 111-2 . . . 111-n are installed. The term “platform” indicates a software system in which to execute an application. Various platforms such as a Java 2 Micro Edition (J2ME) platform and a Java 2 Standard Edition (J2SE) platform, for example, may be used as the platforms 111-1, 111-2 . . . 111-n.

Each platform may perform at least one application. For instance, an application written in C/C++ and a JAVA platform having a JVM (Java Virtual Machine) may be stored in the storage unit 110. These platforms may be installed on the same operating system (OS) or on separate OSs.

The control unit 120 may use a platform stored in the storage unit 110 and perform an application provided by the platform. In this way, an application may perform various functions in the image forming device 100. That is, not only basic functions such as printing, scanning, or copying, for example, but also various other functions such as scan-to-email, scan-to-fax, web browsing, webpage printing, or data downloading and uploading, for example, may be performed. These functions may be realized in various manners, other than those set forth herein, according to the type of application.

The UI processing unit 130 composes an integrated UI displaying all applications executable on each platform. The integrated UI may display information on applications supported by each platform.

The display unit 140 displays the integrated UI provided by the UI processing unit 130 on a screen.

The control unit 120 may control the display unit 140 to display the integrated UI when a certain event occurs. For example, the certain event may include cases when the image forming device 100 is turned on or reset, when a user selects a menu for displaying an integrated UI, or when an image forming job is complete, for example.

A user may select a desired application from the integrated UI. If an application is selected from the integrated UI, the control unit 120 executes the selected application by using a platform corresponding to the selected platform. Accordingly, a function requested by the user is provided.

The UI processing unit 130 may compose the integrated UI by using a main platform among a plurality of platforms 111-1, 111-2 . . . 111-n or by using a platform exclusive for use in configuring an integrated UI.

In a case when an integrated UI is composed by using the main platform, the UI processing unit 130 arranges icons corresponding to applications of the other platforms, i.e., sub-platforms, within a UI layout provided by the main platform. The icon and type of each application may be checked from application information provided by the sub-platforms. Accordingly, the type and shape of each icon may be configured based on application information of each platform.

If the UI processing unit 130 composes an integrated UI by using the main platform, application information provided by the sub-platforms may include icons having an image format that is not supported by the main platform. In this case, the UI processing unit 130 converts the icons having the non-supported image format into an image format supported by the main platform and displays the corresponding icons on the integrated UI.

If the conversion of the icons having the non-supported image format into the supported image format is impossible, the UI processing unit 130 may configure the icons having the non-supported image format as default icons.

On the other hand, if the application information provided by the sub-platforms is in the image format supported by the main platform, the UI processing unit 130 may configure the icons of the sub-platforms based on the application information provided by the sub-platforms.

Information on the integrated UI generated by the UI processing unit 130 is stored in the storage unit 110. The control unit 120 may control the display unit 140 to read out the information on the integrated UI from the storage unit 110 and to display the read-out information upon the occurrence of the above-described event.

Meanwhile, if the platforms stored in the storage unit 110 change, the control unit 120 may control the UI processing unit 130 to update the integrated UI according to changes in the state of the platforms. Accordingly, the integrated UI may be updated to reflect an up-to-date state of the platforms.

As illustrated in FIG. 1, the storage unit 110 may be realized as a memory which is divided into a plurality of sections in which to store a plurality of platforms or as a plurality of memories in which to store a plurality of platforms. In addition, the storage unit 110 may include a shared storage area for storing data shared between a plurality of platforms.

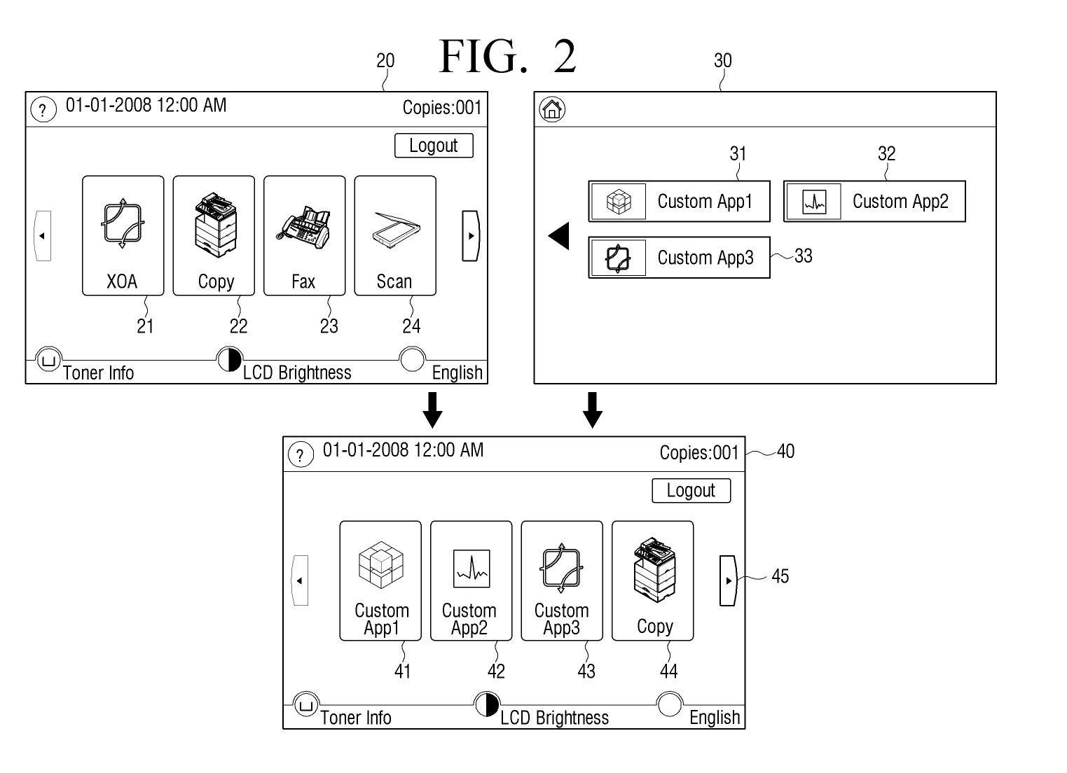

FIG. 2 is a view illustrating an example of the configuration of an integrated UI according to an exemplary embodiment.

Referring to FIG. 2, individual UIs 20 and 30 provided by different platforms may have different layouts and may display different shapes of icons for different applications provided. The image forming device 100 may configure an integrated UI 40 based on application information of each platform. The application information includes the names and icon images of applications and a list of the applications. The integrated UI 40 may maintain the same UI layout and the same shapes of icons as a main platform, for example, the platform corresponding to the UI 20, and display icons for applications displayed in the UI 30, with reference to application information of each platform.

Meanwhile, the main platform may be set by a default setting or a user setting. In a case in which the main platform is set by a user setting, the main platform may be replaced with another platform selected by the user as a new main platform. In this case, the control unit 120 may control the UI processing unit 130 to configure a new integrated UI according to an individual UI of the new main platform.

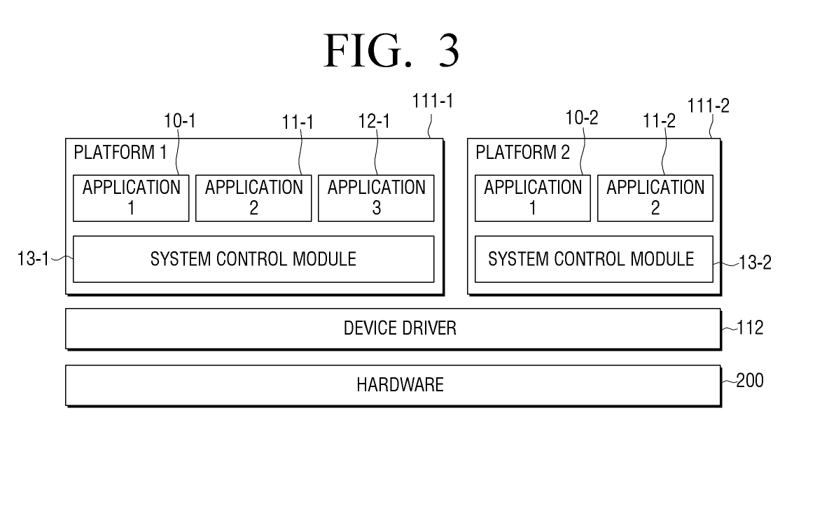

FIG. 3 is a block diagram illustrating an image forming device according to an exemplary embodiment. In FIG. 3, only two platforms 111-1 and 111-2 are illustrated for convenience, but there is no restriction to the number of platforms that may be included in the image forming device 100.

Referring to FIG. 3, the image forming device 100 may include a plurality of first and second platforms 111-1 and 111-2, a device driver 112, and hardware 200. The first and second platforms 111-1 and 111-2 and the device driver 112 may be stored in the storage unit 110. The hardware 200 refers to hardware elements which are operated by the first and second platforms 111-1 and 111-2 stored in the storage unit 110. For example, the hardware 200 may include various kinds of elements which may be used in the display unit 140 such as a button, a speaker, a buzzer, a light-emitting diode (LED), a network communication card, or other image forming operations, for example.

Referring to FIG. 3, the first platform 111-1 provides three applications (i.e., first, second, and third applications 10-1, 11-1, and 12-1), and the second platform 111-2 provides two applications (i.e., first and second applications 10-2 and 11-2). The first and second platforms 111-1 and 111-2 include first and second system control modules 13-1 and 13-2, respectively. The first and second system control modules 13-1 and 13-2 may be realized as software. The control unit 120 of FIG. 1 may perform the above-described operations by implementing the first and second system control modules 13-1 and 13-2.

Specifically, the first and second system control modules 13-1 and 13-2 control the UI processing unit 130 to display a screen which includes various information relating to UI menu configuration, a status of operation, a state of hardware, or an error state, for example. Each of the first and second system control modules 13-1 and 13-2 may operate the hardware 200 via the device driver 112.

If the first platform 111-1 is a main platform, the first system control module 13-1 acquires application information via the second platform 111-2. The first system control module 13-1 may configure an integrated application list by combining its application list with an application list included in the acquired application information. The first system control module 13-1 may configure an integrated UI including the icons of all applications included in the integrated application list, and may store the integrated UI.

The first system control module 13-1 provides the integrated UI to the display unit 140 via the device driver 112. The display unit 140 displays the integrated UI using a displaying element, such as a liquid crystal display (LCD), for example.

If a user selects the first application 10-2 of the second platform 111-2 from the integrated UI, the system control module 13-1 assigns the authority for the control of the hardware 200 to the second system control module 13-2. As described above, the control authority may be transferred between the first and second platforms 111-1 and 111-2, and one of the first and second platforms 111-1 and 111-2 having the control authority may perform various functions by controlling the hardware 200. The first system control module 13-1 and the second system control module 13-2 may include a screen configuring module (not illustrated) for configuring an integrated UI, a display control module (not illustrated) for displaying a UI, a communication module (not illustrated) for communicating with other platforms, and a storage control module for controlling a storing operation.

The storage control module may store information on an image message necessary for configuring a screen, application information generated by other platforms, icon images, and a set value indicating whether a corresponding platform is set as a main platform or a sub-platform.

The first and second platforms 111-1 and 111-2 may share the storage unit 110 or have their own storage units. If the first and second platforms 111-1 and 111-2 share the storage unit 110, the first and second platforms 111-1 and 111-2 may configure an integrated UI by storing application information in the shared storage area in the storage unit 110 and sharing the application information without the need to exchange the application information.

As illustrated in FIG. 2, an integrated UI may be configured to display all applications provided by all platforms available at the same time on the same screen or to display applications on a platform-by-platform basis by using tabs.

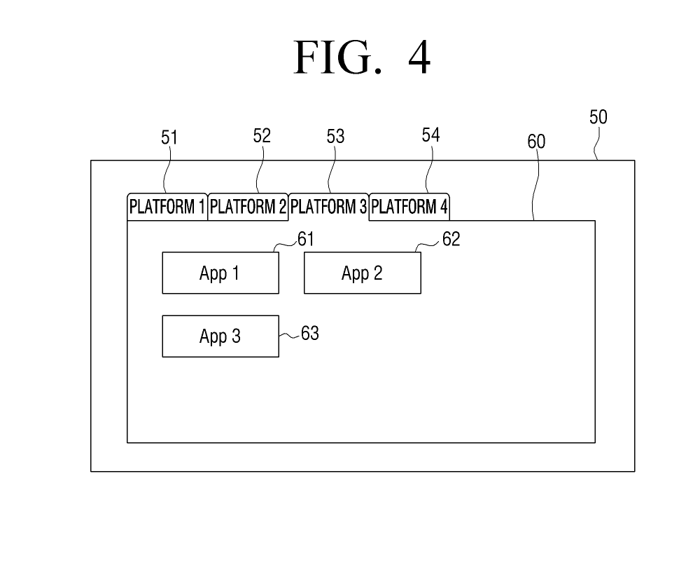

FIG. 4 illustrates an example of an integrated UI which displays applications on a platform-by-platform basis.

Referring to FIG. 4, an integrated UI 50 includes first, second, third, and fourth tab areas 51, 52, 53, and 54 respectively corresponding to platforms 1, 2, 3, and 4 and an icon display area 60 which may display one or more application icons in response to the selection of one of the first, second, third, and fourth tab areas 51, 52, 53, and 54. For example, in response to the selection of the third tab area 53, icons 61, 62, and 63 of applications 1, 2, and 3 that are executable on platform 3 corresponding to the tab area 53 may be displayed in the icon display area 60.

A user may select a desired platform from among platforms 1, 2, 3, and 4 by selecting one of the first, second, third, and fourth tab areas 51, 52, 53, and 54, and may select a desired application icon from the icon displaying area 60 where one or more application icons corresponding to the selected desired platform are displayed.

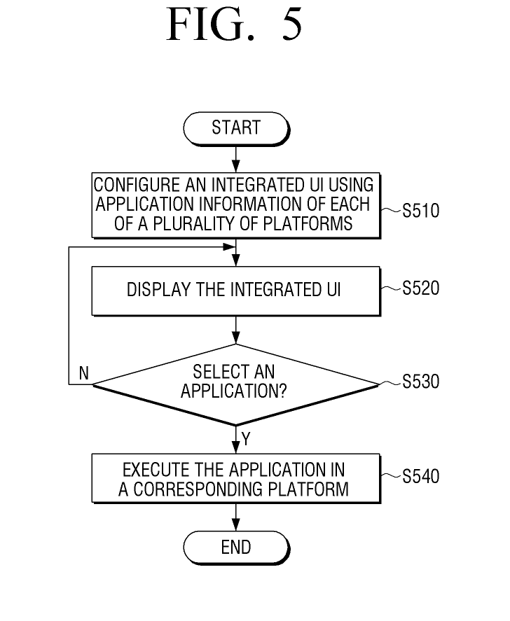

FIG. 5 is a flowchart illustrating an application executing method according to an exemplary embodiment.

Referring to FIG. 5, in operation S510, an image forming device may configure an integrated UI using application information of a plurality of previously-installed platforms. Information on the integrated UI is stored. In operation S520, the image forming device displays the stored integrated UI.

The image forming device 100 may update the integrated UI if there is any change in the platforms or the applications provided by the platforms.

In operation S530, a user may select a desired application from the integrated UI. In operation S540, the image forming device performs the selected application by using a platform that supports the selected application.

That is, if the platform that supports the selected application is a sub-platform, a main platform assigns a control authority to the sub-platform, and the sub-platform performs the selected application and displays an execution screen relevant to the application via the display unit 140.

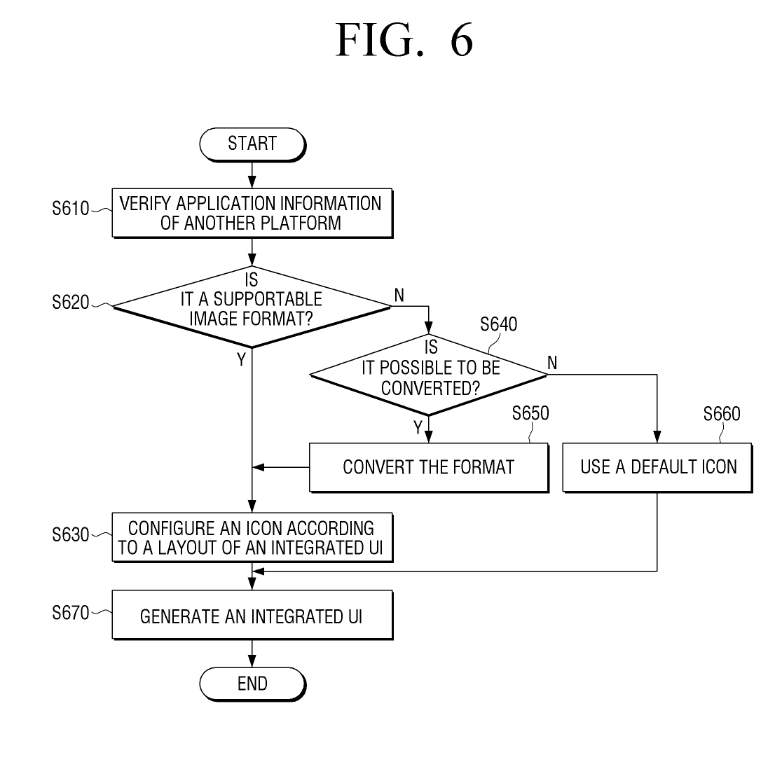

FIG. 6 is a flowchart illustrating a method of configuring an integrated UI, according to an exemplary embodiment. Referring to FIG. 6, in operation S610, a main platform of an image forming device may check application information on applications provided by other platforms. The application information may include a list of applications, the button images or icon images of the applications, button captions or icon captions of the applications, or unique information, for example, which needs to be transferred in response to the receipt of a user's request for the execution of an application.

A sub-platform may be provided, in addition to the main platform, with the application information, if necessary.

The application information may be transmitted or received directly between platforms. However, if a shared storage area is provided, the application information may be stored in the shared storage area, and location or path information of the location where the application information is stored may be transmitted between platforms.

A platform may be set as a main platform or a sub-platform by a user setting or a default setting. Each platform may determine whether they are main platforms or sub-platforms based on a set value present in the storage unit 110.

In operation S610, the application information is checked. In operation S620, whether button images or icon images included in the application information have an image format supported by the main platform is checked. For instance, if the main platform only supports JPEG images and application icon images to be displayed are PNG images, the main platform may determine that the application icon images to be displayed have an image format that is not supported by the main platform. Alternatively, if the application icon images to be displayed are JPEG images, the main platform may determine that the application icon images to be displayed have an image format that is supported by the main platform.

In operation S630, if icons included in the application information are determined to have an image format supported by the main platform, the icons may be arranged in an integrated UI layout as they are in the application information. In operation S670, an integrated UI may be configured by adjusting the size of the icons and the length and the font size of captions displayed in the icons in accordance with the size or shape of the integrated UI layout.

Meanwhile, in operation S640, if the application information includes an image having an image format not supported by the main platform, the main platform determines whether it can perform the conversion of the image. For example, the main platform may determine whether it has an image conversion module. If the main platform does not have an image conversion module, the main platform may request a sub-platform equipped with an image conversion module to convert the image and provide the converted image.

In operation S650, if the main platform is determined to be able to convert the image in operation S640, the main platform converts the format of the image, and arranges the converted image in the integrated UI layout. In this manner, in operation S670, an integrated UI may be generated.

On the other hand, in operation S650, if the main platform is determined to be able to convert the image, the main platform may use a default icon in operation S660 and may generate an integrated UI in operation S670.

If a user selects an application supported by a sub-platform from the integrated UI, the main platform transmits unique identification information for checking the selected application such as an application execution request including an identifier (ID) of the selected application, for example, to the sub-platform. The main platform transfers a control authority over a screen and UI hardware to the sub-platform. Accordingly, the sub-platform may execute the selected application.

The above-described exemplary embodiments illustrate cases where a main platform composes an integrated UI, but a sub-platform may compose an integrated UI.

Icon forms of an integrated UI may be configured individually according to application information of each of a plurality of platforms. That is, an application icon displayed on an individual UI of a main platform and an application icon displayed on an individual UI of a sub-platform may be displayed on the integrated UI with an icon form displayed on each UI.

If a pre-stored platform changes, updating the integrated UI according to a state of the changed platform may be further included even though FIGS. 5 and 6 do not illustrate such a case.

In addition, the above-described exemplary embodiments describes based on the image forming device 100, but the methods for displaying an integrated UI and executing an application may be applied to various types of devices as well as the image forming device. That is, it may be applied to displaying devices installing a plurality of platforms therein, such as a TV, mobile phone, PC, laptop, tablet PC, PDA, or electronic photo frame, for example.

In addition, a program to perform the methods for displaying an integrated UI and executing an application may be provided separately and recorded in a recording medium. A device installing the recording medium therein may perform the method for displaying an integrated UI and executing an application by executing a corresponding program.

The above-described embodiments may be recorded in computer-readable media including program instructions to implement various operations embodied by a computer. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The computer-readable media may also be a distributed network, so that the program instructions are stored and executed in a distributed fashion. The program instructions may be executed by one or more processors. The computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The above-described devices may be configured to act as one or more software modules in order to perform the operations of the above-described embodiments, or vice versa.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. An image forming device, comprising:
a storage unit having a plurality of platforms;
a user interface (UI) processing unit to configure an integrated UI which displays applications executable in each platform;
a display unit to display the integrated UI; and
if an application is selected from the integrated UI, a control unit executing the selected application using a platform corresponding to the selected application.

2. The device of claim 1, wherein the UI processing unit configures the integrated UI using a main platform among the plurality of platforms and provides the integrated UI with icons for applications executable in each platform according to application information of a sub-platform among the plurality of platforms.

3. The device of claim 2, wherein forms of the icons are configured individually according to application information of each of the plurality of platforms.

4. The device of claim 3, wherein if application information provided in the sub-platform among the plurality of platforms is an image format supportable in the main platform, the UI processing unit configures icons of applications of the sub-platform according to the application information, and if the application information is an image format that is not supportable in the main platform, configures icons of applications of the sub-platform by converting application information into an image format of the main platform and, if a conversion into the image format is not possible, configures application icons of the sub-platform in a form of default icons.

5. The device of claim 1, wherein, if a platform stored in the storage unit changes, the control unit controls the UI processing unit to update the integrated UI according to a state of the changed platform.

6. The device of claim 1, wherein the storage unit comprises a plurality of platform areas assigned for each of the plurality of platforms and a shared storage area storing data shared in the plurality of platforms.

7. The device of claim 1, wherein the integrated UI includes a tab area displayed corresponding to the plurality of platforms and an icon display area, and the icon display area is displayed in connection with selecting the tab area and displays icons of applications executable in a corresponding platform.

8. A method for executing an application, the method comprising;
configuring an integrated user interface (UI) displaying applications executable in a plurality of pre-installed platforms;
displaying the integrated UI; and
if an application is selected from the integrated UI, executing the selected application using a platform corresponding to the selected application.

9. The method of claim 8, wherein the integrated UI is configured by a main platform among the plurality of platforms and comprises icons of applications executable in a sub-platform among the plurality of platforms.

10. The method of claim 9, wherein forms of the icons are configured individually according to application information of each of the plurality of platforms.

11. The method of claim 10, wherein the configuring the integrated UI comprises:
forming a layout of an integrated UI using the main platform among the plurality of platforms;
determining whether application information provided in the sub-platform among the plurality of platforms is an image format supportable in the main platform;
in the case of a supportable image format, configuring application icons of the sub-platform according to the application information and, in the case of an image format that is not supportable in the main platform, determining whether it is possible to convert the application information into an image format of the main platform; and
if it is possible to convert into an image format of the main platform, configuring application icons of the sub-platform as the image format of the main platform and, if it is not possible to convert into the image format, configuring application icons of the sub-platforms in a form of default icons.

12. The method of claim 8, further comprising:
if a pre-stored platform changes, updating the integrated UI according to a state of the changed platform.

13. The method of claim 8, wherein the integrated UI includes a tab area corresponding to the plurality of platforms and an icon display area, and the icon display area is displayed in connection with selecting the tab area and displays icons of applications executable in a corresponding platform.

14. A method for providing an integrated user interface (UI) of the image forming device, the method comprising:
detecting application information of another platform by a main platform among a plurality of platforms installed in the device;
configuring an integrated UI displaying applications executable in the plurality of platforms according to a UI format provided in the main platform; and
displaying the integrated UI.

15. A non-transitory computer-readable recording medium storing a program to implement the method of claim 8.

16. The device of claim 1, wherein the display unit displays the integrated UI after the occurrence of at least one of the image forming device being turned on, the image forming device being reset, a user selecting a menu for displaying the integrated UI, and completion of an image forming job.

17. The device of claim 1, wherein the storage unit stores at least one of information on an image message necessary for configuring a screen, application information generated by another platform, an icon image, and a set value indicating whether a corresponding platform is set as a main platform or a sub-platform.
